(19) United States
(12) Patent Application Publication
(10) Pub. No.: US 2025/0056469 A1
(43) Pub. Date: Feb. 13, 2025

(54) TIMING ERROR GROUPS FOR TRANSMISSION TIMING ERRORS OF POSITIONING REFERNCE SIGNALS

(71) Applicant: Sony Group Corporation, Tokyo (JP)

(72) Inventors: Basuki PRIYANTO, Lund (SE); Yujie ZHANG, Lund (SE); Anders BERGGREN, Lund (SE)

(21) Appl. No.: 18/718,646

(22) PCT Filed: Dec. 22, 2022
(86) PCT No.: PCT/EP2022/087595

§ 371 Date: Jun. 11, 2024

(30) Foreign Application Priority Data
Dec. 22, 2021 (SE) 2151611-7

(51) Int. Cl. H04W 64/00; H04L 5/00; H04W 24/10

(52) U.S. Cl. CPC H04W 64/00; H04L 5/0051; H04W 24/10

(57) ABSTRACT

Various examples of the disclosure generally relate to timing error groups and timing error group reports of transmission timing errors, specifically uplink transmission timing errors of uplink positioning reference signals. Thereby, high-accuracy positioning of a wireless communication device is enabled.

### TECHNICAL FIELD

Various examples of the disclosure generally relate to positioning measurements and to determining of a position of a wireless communication device based on uplink positioning reference signals that are transmitted by the wireless communication device. Various examples of the disclosure specifically relate to measuring and reporting of uplink transmission timing errors when transmitting the positioning reference signals. Various examples specifically relate to timing error groups.

### BACKGROUND

Wireless communication devices (hereinafter, user equipment; UE) that can connect to a cellular network (NW) exhibit mobility. Positioning measurements can be carried out to determine a position of the UEs.

One option to determine the position of a UE is an uplink (UL) time difference of arrival (TDOA) measurement. For UL TDOA measurements, the UE transmits positioning reference signals, e.g., sounding reference signals (SRSs). One or more base stations (BSs) attempt to receive (monitor for) the positioning reference signals (PRSs). Based on differences in the propagation delay and the position of the base-station(s), the position of the UE can be determined. Typically, the position of the UE can be determined at a respective location server node (LS).

The Third Generation Partnership Project (3GPP) New Radio (NR) in Rel-17 has defined high accuracy positioning requirement, particularly for the industrial factory scenario (i.e., with 20 cm horizontal accuracy). High accuracy positioning aspect is expected to be continuously evolved in the subsequent 3GPP releases, including even higher accuracy positioning requirement, and high accuracy positioning in challenging scenarios. However, the timing error caused by the BS hardware and/or UE hardware (i.e., RF front-end, baseband) during positioning signal transmission and reception can reduce the UE positioning accuracy. For example, a timing error of 1 ns can result in a 30 cm deviation in accuracy.

One specific timing error is the UL transmission (TX) timing error adding variable time delay to signals—in particular PRSs—transmitted by the UE.

To mitigate respective positioning inaccuracies, it has been proposed to report UL TX timing errors. The UE can measure the UL TX timing errors by monitoring the operation of UE TX chains used to transmit PRSs.

One option to report timing errors is to use a timing error group (TEG) report. A TEG defines which UL PRSs exhibit comparable UL TX timing errors.

See 3GPP R1-2106091, where it is explained that for mitigating UE Tx timing errors for UL TDOA, a UE can provide association information of UL SRS resources for positioning with Tx TEGs. Such association information thus, according to prior art implementations, implements TEG report. The TEG report can be provided to a so-called Location Management Function (LMF), implementing the LS in 3GPP NR core network.

The LS can utilize information on TEGs to eliminate the timing error, by basing positioning on SRS measurements belonging to the same TEG, such that the errors will cancel out each other.

It has been found that timing errors oftentimes vary over the course of time, e.g., due to temperature changes, panel shifting, RF chain shifting, etc. Hence, the TEGs may change over time, which may affect positioning accuracy.

### SUMMARY

There is a need for advanced techniques of reporting uplink transmission timing errors. Specifically, there is a need for advanced techniques of configuring and providing TEG reports.

This need is met by the features of the independent claims. The features of the dependent claims define embodiments.

A method of facilitating positioning of a wireless communication device is provided. The method is for use in the wireless communication device, the wireless communication device being connected to a cellular network. The cellular network includes at least one base station. The method includes obtaining at least one measurement time duration. The at least one measurement time duration is for making measurements of uplink transmission timing errors. The uplink transmission timing errors are associated with transmitting of positioning reference signals. Each one of the at least one measurement time duration includes at least one resource set for said transmitting of the positioning reference signals. The method also includes transmitting the positioning reference signals for reception by the at least one base station of the cellular network. Said transmitting is during the at least one measurement time duration. Said transmitting uses the at least one resource set. The method also includes providing a timing error group report to the cellular network. This is based on the measurements of the uplink transmission timing errors at the wireless communication device during the at least one measurement time duration. The timing error group report is indicative of a change of parameter values of at least one parameter that is associated with the timing error groups during the measurement time duration. Each timing error group includes one or more resources of at least one resource set having uplink transmission timing errors within a predefined margin.

A computer program or a computer program product includes program code. The program code can be loaded and executed by at least one processor. Execution of the program code causes the at least one processor to perform a method of facilitating positioning of a wireless communication device is provided. The method is for use in the wireless communication device, the wireless communication device being connected to a cellular network. The cellular network includes at least one base station. The method includes obtaining at least one measurement time duration. The at least one measurement time duration is for making measurements of uplink transmission timing errors. The uplink transmission timing errors are associated with transmitting of positioning reference signals. Each one of the at least one measurement time duration includes at least one resource set for said transmitting of the positioning reference signals. The method also includes transmitting the positioning reference signals for reception by the at least one base station of the cellular network. Said transmitting is during the at least one measurement time duration. Said transmitting uses the at least one resource set. The method also includes providing a timing error group report to the cellular network. This is based on the measurements of the uplink transmission timing errors at the wireless communication device during the at least one measurement time duration. The timing error group report is indicative of a change of parameter values of at least one parameter that is associated with the timing error groups during the measurement time duration. Each timing error group includes one or more resources of at least one resource set having uplink transmission timing errors within a predefined margin.

A method of positioning a wireless communication device is provided. The method is for use in a network node of a cellular network, e.g., a location server or a base station. The wireless communication device is connected to the cellular network. Said positioning is based on time-difference of arrival measurements of positioning reference signals that are transmitted by the wireless communication device for reception by at least one base station of the cellular network. The method includes obtaining one or more positioning measurement reports from the at least one base station. These one or more positioning measurement reports are indicative of times of arrival of the positioning reference signals at the at least one base station. Also, the method includes obtaining a timing error group report. The timing error group report is indicative of a change of parameter values of at least one parameter that is associated with timing error groups during a predetermined measurement time duration. The predetermined measurement time duration is for making measurements of uplink transmission timing errors associated with transmitting the positioning reference signals. Each timing error group includes one or more resources of the at least one resource set having uplink transmission timing errors that are within a predefined margin. Further, the method includes determining a position of the wireless communication device. The position is determined based on the timing error group report as well as the one or more positioning measurement reports.

A computer program or a computer program product includes program code. The program code can be loaded and executed by at least one processor. Execution of the program code causes the at least one processor to perform a method of positioning a wireless communication device is provided. The method is for use in a network node of a cellular network, e.g., a location server or a base station. The wireless communication device is connected to the cellular network. Said positioning is based on time-difference of arrival measurements of positioning reference signals that are transmitted by the wireless communication device for reception by at least one base station of the cellular network. The method includes obtaining one or more positioning measurement reports from the at least one base station. These one or more positioning measurement reports are indicative of times of arrival of the positioning reference signals at the at least one base station. Also, the method includes obtaining a timing error group report. The timing error group report is indicative of a change of parameter values of at least one parameter that is associated with timing error groups during a predetermined measurement time duration. The predetermined measurement time duration is for making measurements of uplink transmission timing errors associated with transmitting the positioning reference signals. Each timing error group includes one or more resources of the at least one resource set having uplink transmission timing errors that are within a predefined margin. Further, the method includes determining a position of the wireless communication device. The position is determined based on the timing error group report as well as the one or more positioning measurement reports.

A method of facilitating positioning of a wireless communication device is provided. The method is for use in a base station of a cellular network. The wireless communication device is connected to the cellular network. Said positioning is based on time-difference of arrival measurements of positioning reference signals. The positioning reference signals are transmitted by the wireless communication device for reception by at least one base station of the cellular network. The method includes providing a control message to the wireless communication device. This control message is indicative of at least one measurement time duration for making measurements of uplink transmission timing errors. The uplink transmission timing errors are associated with transmitting the positioning reference signals. The method also includes obtaining a timing error group report. The timing error group report is indicative of a change of parameter values of at least one parameter that is associated with timing error groups during the at least one measurement time duration. Each timing error group includes one or more resources of the at least one resource set having uplink transmission timing errors that are within a predefined margin.

A computer program or a computer program product includes program code. The program code can be loaded and executed by at least one processor. Execution of the program code causes the at least one processor to perform a method of facilitating positioning of a wireless communication device is provided. The method is for use in a base station of a cellular network. The wireless communication device is connected to the cellular network. Said positioning is based on time-difference of arrival measurements of positioning reference signals. The positioning reference signals are transmitted by the wireless communication device for reception by at least one base station of the cellular network. The method includes providing a control message to the wireless communication device. This control message is indicative of at least one measurement time duration for making measurements of uplink transmission timing errors. The uplink transmission timing errors are associated with transmitting the positioning reference signals. The method also includes obtaining a timing error group report. The timing error group report is indicative of a change of parameter values of at least one parameter that is associated with timing error groups during the at least one measurement time duration. Each timing error group includes one or more resources of the at least one resource set having uplink transmission timing errors that are within a predefined margin.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates UL-TDOA positioning measurements based on positioning reference signals transmitted by a UE and received at multiple base stations according to various examples.

FIG. 2 schematically illustrates a UE according to various examples.

FIG. 3A schematically illustrates a location server of a cellular NW according to various examples.

FIG. 3B schematically illustrates a base station of a cellular NW according to various examples.

FIG. 4 schematically illustrates using multiple positioning reference signals and associated resources of a resource that according to various examples.

FIG. 5 schematically illustrates a timing error observed for multiple positioning reference signals and associated timing error groups according to various examples.

FIG. 6 schematically illustrates a positioning measurement window and a measurement time duration for measuring timing errors according to various examples.

FIG. 7 schematically illustrates a positioning measurement window and a measurement time duration for measuring timing errors according to various examples.

FIG. 8 schematically illustrates a positioning measurement window and a measurement time duration for measuring timing errors according to various examples.

FIG. 9 is a flowchart of a method according to various examples.

FIG. 10 is a flowchart of a method according to various examples.

FIG. 11 is a signaling diagram of communication between a UE, multiple base stations and a location server according to various examples.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only. Hereinafter, techniques of determining the position or location of a UE will be disclosed. The position of the UE can be determined with respect to one more base stations (BS) of a cellular network (NW). The position of the UE can be determined in a reference coordinate system in which the one or more BSs of the cellular NW have defined positions.

As a general rule, the BS can be implemented in 3GPP NR by a gNB or a transmit receive point (TRP). TRP is a transmission point of a gNB. A gNB may have multiple TRPs.

The position of the UE can be determined by a LS, e.g., a 3GPP LMF.

Hereinafter, techniques of performing positioning measurements of the position of the UE are disclosed. For instance, 3GPP NR positioning supports various positioning measurement types, including downlink (DL)-TDOA, UL-TDOA, and multi-cell round trip time (Multi-RTT).

The positioning measurements as described herein can be specifically implemented by UL-TDOA, i.e., based on UL PRSs transmitted by the UE. One more BSs of the cellular NW to which the UE is connected can monitor for the uplink PRSs and based on differences in the reception time, a multilateration and/or multiangulation of the position of the UE becomes possible. The positioning measurements of the propagation time reflect the distance between UE and BS. UL-TDOA, DL-TDOA, Multi-RTT all rely on positioning measurements of the propagation time; thus, while hereinafter example techniques are disclosed in the framework of UL-TDOA, similar techniques may be also applied for other timing-based positioning measurements, e.g., DL-TDOA.

Positioning measurements of the propagation time can be generally affected by timing errors.

For instance, a transmission (TX) timing error can be seen from a signal transmission perspective. There will be a time delay from the time when the digital signal is generated at baseband to the time when the RF signal is transmitted from the Tx antenna.

Reception (RX) timing errors can be seen from a signal reception perspective, there will be a time delay from the time when the RF signal arrives at the Rx antenna to the time when the signal is digitized and timestamped at the baseband.

According to various examples, TX timing errors can be measured and reported.

Next, TX timing error measurements will be described. For instance, the transmitting of PRSs in a TX signal processing chain can be monitored by the UE—e.g., using RF circuitry—and based on said monitoring the transmission timing error can be determined. For instance, a delay clock can measure the time between generating the digital signal at baseband to the time when the radiofrequency signal is transmitted from the transmit antenna, to determine the transmission timing error. A time-to-digital converter could be used. These are device-centric measurements of the UL TX timing error.

Typically, a transmitting or receiving device will include multiple transmit signal processing chains or receive signal processing chains. Such signal processing chains can include digital circuitry and analog circuitry. A digital to analog converter or an analog to digital converter can be provided. Amplifiers and/or phase shifters can be provided. Interleaving and/or scrambling could be performed. Modulation can be applied.

Depending on which specific signal processing chain is involved in transmitting or receiving, different timing errors can be observed. This means, that signals transmitted using different digital signal processing chains at the transmitter device will generally exhibit different transmission timing errors.

Sometimes, even where signals are processed in the same signal processing chain, different timing errors can be observed.

Timing errors can also over the course of time.

This finding has an impact on positioning measurements, specifically on UL-TDOA measurements. This is explained next.

Oftentimes, UL PRSs for UL-TDOA will be transmitted by the UE in bursts. This means that multiple PRSs will be transmitted in different spatial directions by using different antenna precoding utilizing the plurality of antenna elements and/or antenna panels. Thereby, reception of the uplink PRSs by multiple BSs of the cellular NW arranged at different spatial positions can be facilitated. To enable the transmission of multiple PRSs, resource sets can be allocated that define time-frequency resources in a time-frequency resource grid on a wireless channel and different resources can be allocated to different PRSs of a respective burst. Here, different resources of the resource set can be associated with using different signal processing chains.

As a result, different resources of the resource set that can accommodate PRSs that exhibit different timing errors, specifically (but not only) if transmitted using different TX signal processing chains.

Thus, resources of a resource set used for PRS transmission (or the respective PRSs) can be grouped into TEGs, depending on their error levels and/or their tolerance of error levels (error margin). For instance, two resources can belong to the same TEG, if their error level are the same within a predetermined tolerance.

The TEGs can facilitate reporting of timing errors. Specifically, it is possible to group timing errors of different PRSs into the TEGs according to their error levels and/or tolerance, and thereby reduce the control signaling overhead required to inform the cellular NW of the timing errors.

The cellular NW can use the TEG report when performing the position of the UE; for instance, when a timing difference is observed for time-of-arrival of two different positioning reference signals received at 2 different base stations (and transmitted using different resources), this can have multiple reasons. Firstly, it would be possible that the different positioning reference signals have different uplink transmission timing errors which results in the timing differences (this contribution to the timing difference typically prevents from accurate positioning of the UE and thus can be labeled “undesired” contribution); alternatively or additionally, secondly, it would be possible that the different positioning reference signals propagate along different transmission paths—having different lengths—which results in the timing difference (this contribution to the timing difference is the contribution that allows for UE positioning and thus can be labeled the “desired” contribution). By using positioning reference signals from the same TEGs, it can be ensured that the contribution from different uplink transmission timing errors is smaller than a certain predetermined threshold that is associated with the tolerance of timing errors in this transmission error group.

Based on the TX timing errors, is then possible to define TEGs. See TAB. 1.

TABLE 1
Various examples of TEGs of timing errors when transmitting or receiving signals.
According to various examples, UE TX TEG reports can be provided.

| Error Group | Description |
|---|---|
| UE TX TEG | A UE TX TEG is associated (respective association information |
| | can be defined) with the transmissions of PRSs on |
| | of one or more UL PRS resources for the positioning purpose, |
| | which have the Tx timing errors within a certain margin. |
| | As a general rule, this margin pertains to the absolute baseline |
| | of the uplink transmission timing error, e.g., in nanoseconds) |
| | and/or the tolerance of the error level between different |
| | resources associated with that TEG. |
| | For instance, a UE can be requested to report the Tx TEG; |
| | the TEG report could then include association information |
| | between UE Tx TEG identities of multiple TEGs and PRSs |
| | resources for of PRSs used for positioning. |
| | Then, the UE may, in one example, report, e.g., TEG 1 including |
| | PRS resources 2, 3, 7, 8; while TEG 2 includes PRS |
| | resources 1, 4, 5, 6. |
| BS Tx TEG | A BS Tx TEG is associated with the transmissions of one or |
| | more DL PRS resources, which have the Tx timing errors |
| | within a certain margin. |
| UE Rx TEG | A UE Rx TEG is associated with one or more DL measurements, |
| | which have the Rx timing errors within a certain margin. |
| BS Rx TEG | A BS Rx TEG is associated with one or more UL measurements, |
| | which have the Rx timing errors within a margin. |
| UE RxTx TEG | A UE RxTx TEG is associated with one or more UE Rx − Tx |
| | time difference measurements, and one or more UL PRS |
| | resources for the positioning purpose, which have the ‘Rx |
| | timing errors + Tx timing errors’ within a certain margin. |
| BS RxTx TEG) | A BS RxTx TEG is associated with one or more BS Rx − Tx |
| | time difference measurements and one or more DL PRS |
| | resources, which have the ‘Rx timing errors + Tx timing errors’ |
| | within a certain margin. |

Various techniques disclosed herein facilitate configuring of TEG reporting and provisioning TEG reports, i.e., provisioning up-to-date and accurate information regarding which resources of a resource set of PRSs have TX timing errors within a certain margin.

Hereinafter, some techniques will be described that can help to configured TEG reporting and providing of TEG reports. The techniques disclosed herein can be implemented isolated and on its own or in combination. Some respective techniques are summarized in TAB. 2.

TABLE 2
Various aspects of the present disclosure associated with configuring
TEGs and reporting of TEGs. Such aspects as disclosed herein can be
used in isolation or in combination according to the various examples.

| | Technique | Example description |
|---|---|---|
| I | Variable | A first technique disclosed herein are based on the finding that |
| | measurement | UL TX timing errors can vary on various timescales. Further, |
| | time duration | this timescale of variation can itself vary over time. For |
| | for UL TX | instance, TX timing errors may change due to variation among |
| | timing error | timing errors within one TEG. The absolute value of a TEG |
| | measurements | may change. The grouping may change. |
| | | At some instances, UL TX timing errors can vary on short timescales. |
| | | Another example pertains to a UE operating in different |
| | | or multiple frequency bands of frequency ranges. Here, the UE |
| | | needs to change RF filters frequently, which results in changes |
| | | to the timing errors. Yet another example pertains to heavy |
| | | load at the UE which can increase the heat generation and this |
| | | can affect the operation of the RF hardware, leading to |
| | | changes in the timing errors |
| | | At other instances, UL TX timing errors can vary on long timescales, |
| | | e.g., in case the UE is comparably static and environmental |
| | | conditions do not change significantly. |
| | | Thus, sometimes a previous TEG report may be outdated such |
| | | that a corresponding positioning measurement that is based |
| | | on the TEG report would be inaccurate; while a similarly “old” |
| | | TEG report may be still valid at other instances. |
| | | To address this, a measurement time duration during which |
| | | the TX timing error is determined can be tailored, e.g., determined |
| | | to be shorter in some instances (to thereby measure |
| | | more frequently) or longer in other instances (to thereby measure |
| | | the UL TX timing error less frequently. |
| | | Thus, according to examples, the UE may obtain at least one |
| | | measurement time duration, wherein measurements of the UL |
| | | TX timing error are performed during the measurement time |
| | | duration. Each one of the at least one measurement time duration |
| | | can accordingly include at least one resource set for |
| | | transmitting the UL PRSs. Based on measurements of UL TX |
| | | timing errors of the PRSs at the UE during the measurement |
| | | time duration, the UE can provide, to the cellular NW, the TEG |
| | | report, e.g., during or after the measurement time duration. |
| | | The TEG report may be indicative of a change of parameter |
| | | values of at least one parameter associated with TEGs during |
| | | the measurement time duration. |
| | | Thus, the measurement time duration can be seen as an observation |
| | | window during which the UL TX timing error is sampled |
| | | by the UE. Changes can be detected, e.g., with respect to |
| | | a previous timing error or even of the timing error within the |
| | | measurement time duration. Such changes can then be reported. |
| | | More frequent measurement time durations result in a |
| | | higher time resolution with which the timing errors are sam- |
| | | pled; thereby generally leading to more accurate TEG reports. |
| | | The UE may obtain measurement time durations at least once. |
| | | Furthermore, the UE may obtain multiple times, i.e., repeatedly - |
| | | e.g., periodically or aperiodically - obtain measurement time |
| | | durations. Periodically means the obtain the information in a |
| | | deterministic/regular pattern. Aperiodic means the UE obtain |
| | | the information in a non-deterministic pattern (e.g., it is only |
| | | provided when there is a need to change it). Thus, over the |
| | | course of UE operation - e.g., when the UE operates in connected |
| | | mode - updates to the measurement time durations |
| | | may be obtained. In other words, the measurement time duration |
| | | may be dynamically updated, e.g., while the UE operates |
| | | in a connected mode towards the cellular NW. |
| | | By obtaining the measurement time duration, the measurement |
| | | time duration can be tailored to the circumstances. For |
| | | some instances, longer measurement time durations may be |
| | | helpful while for other circumstances, shorter measurement |
| | | time durations may be helpful. |
| | | For instance, the measurement time duration may be obtained |
| | | from the cellular NW. For example, as a general rule, the |
| | | measurement time duration could be obtained from a LS or a |
| | | BS, e.g., serving BS. |
| | | Obtaining the measurement time duration may include obtaining |
| | | a control message that is indicative of the measurement |
| | | time duration from the cellular NW. For instance, the LS could |
| | | configure the measurement time duration. This could be based |
| | | on application-level considerations, e.g., certain applications |
| | | may require high accuracy in positioning of the UE than other |
| | | applications. Generally, a target positioning accuracy could be |
| | | considered. This could also be based on mobility levels of the |
| | | UE. |
| | | Sometimes it would be possible that the UE obtains multiple |
| | | measurement time durations. Thereby, repeated measurements |
| | | of the UL TX timing error within subsequent measurement |
| | | time duration becomes possible. |
| | | It is not required in all scenarios that the measurement time |
| | | duration is determined at a node of the cellular NW, e.g., at the |
| | | LS. In some instances, the measurement time duration could |
| | | also be fully or at least partly determined at the UE. Obtaining |
| | | of the measurement time duration could thus, as a general |
| | | rule, include loading the measurement time duration from a |
| | | memory at the UE. For instance, it would be possible that obtaining |
| | | the at least one measurement time duration at the UE |
| | | includes calculating a start time and the stop time of the at least |
| | | one measurement time duration in accordance with a respective |
| | | repetitive timing schedule. such repetitive timing schedule |
| | | could be parametrized. For instance, depending on the values |
| | | of certain parameters - e.g., the UE mobility level or coverage |
| | | situation - different timings of the start time and the stop time |
| | | of the measurement time duration may apply. The UE can locally |
| | | determine the parameter values of such parameters of the |
| | | repetitive timing schedule and then calculate the concrete |
| | | instance of the measurement time duration locally. Again, it |
| | | would be possible that the repetitive timing schedule is configured |
| | | by the cellular NW, e.g., provided to the UE by the LS. In |
| | | other scenarios, the determination of the at least one measurement |
| | | time duration may be implemented only at the UE and |
| | | be fully transparent to the cellular NW. |
| II | Variable TEG | In some examples it is possible to provide a TEG report in |
| | reporting | accordance with a reporting ruleset that can be tailored. |
| | ruleset | Thus, generally, the providing of the TEG report may be varied |
| | | independently of the variation of the at least one measurement |
| | | time duration (cf. example I above). In other examples, the |
| | | providing of the TEG report may also correlate with the at least |
| | | one measurement time duration. |
| | | For instance, it would be possible that the UE obtains the reporting |
| | | ruleset from the cellular NW. For instance, the LS could |
| | | configure the reporting ruleset and provide the reporting |
| | | ruleset for reporting the TEGs to the UE. |
| | | The reporting ruleset could be obtained multiple times by the |
| | | UE (i.e., changed over the course of time). For instance, the |
| | | reporting ruleset could be dynamically or repeatedly - e.g., |
| | | periodically or aperiodically - obtained by the UE, i.e., obtained |
| | | multiple times. Thus, the reporting ruleset may be updated |
| | | from time-to-time, e.g., while the UE operates in the connected |
| | | mode. |
| | | For instance, the reporting ruleset could define at least one |
| | | trigger event that triggers providing a TEG report. |
| | | Thereby, TEG reports can be provided on demand, e.g., where |
| | | needed due to a (significant) change of a parameter value of |
| | | at least one parameter associated with the TEGs. |
| | | For instance, it would be possible to define thresholds. The at |
| | | least one trigger event may then include a change of at least |
| | | one parameter value of a parameter associated with the TEGs |
| | | exceeding a respective predefined threshold. |
| | | Thus, the LS may assume that as long as no TEG reports are |
| | | received, the respective parameter values remains static. For |
| | | instance, this would mean that association information between |
| | | PRS resources of a respective resource set and TEGs |
| | | remains static. Alternatively or additionally, this could mean |
| | | that a margin of the transmission errors associated with each |
| | | TEG remains static. |
| | | It is not required in all scenarios to define event-triggered TEG |
| | | reporting. Also, time-triggered TEG reporting would be conceivable. |
| | | The reporting ruleset could define a timing schedule for repeatedly - |
| | | e.g., periodically or aperiodically - providing the TEG |
| | | report. I.e., the reporting ruleset can be provided multiple times |
| | | (i.e., updated from time to time). |
| | | Sometimes, the providing of the TEG report - typically using |
| | | Layer 3/Radio Resource Control (RRC) signaling -, can be |
| | | delayed. This can occur due to collisions with other data to be |
| | | transmitted. This can cause a risk of latency for determining |
| | | the positioning of the UE, if the TEG report arrives late. |
| | | Preferably, the BS should have available the TEG report together |
| | | with the positioning measurement report so that both can be |
| | | provided to the LS. |
| | | To achieve this, according to various examples, it would be |
| | | possible that a timing schedule for repeatedly - e.g., periodically |
| | | or aperiodically - providing the TEG report defines a maximum |
| | | duration of a time gap (i.e, an upper limit) between an |
| | | end of a measurement time duration for determining the UL TX |
| | | timing errors and providing of the TEG report. Alternatively or |
| | | additionally, such time gap could also be defined with respect |
| | | to different resources or resource sets used for transmitting |
| | | PRSs. |
| | | Thus, it is possible to configure - e.g., by the cellular NW of |
| | | the UE, a maximum time until which the TEG report is to be sent. |
| III | Variable TEG | Still further, it is possible to increase the positioning accuracy |
| | reporting | by tailoring or even augmenting the content of TEG reports. |
| | information | In some instances, at least one parameter for which a parameter |
| | content | value - possibly changed during the measurement time |
| | | duration, cf. example I - is reported in the TEG report can |
| | | include the association information, i.e., associations between |
| | | one or more resources of a resource set for PRSs and TEGs. |
| | | Accordingly, it can be specified which PRSs have similar error |
| | | level within a predefined margin that is associated with the |
| | | respective TEG. |
| | | Alternatively or additionally, the at least one parameter could |
| | | include identities of one or more resources associated with |
| | | each TEG. Thus, the specific resources included in each TEG |
| | | can be explicitly signaled. |
| | | Alternatively or additionally, the at least one parameter could |
| | | also include the predefined margin. This means that the UE |
| | | could report the error level and/or error tolerance associated |
| | | with each TEG. For instance, it would be possible to report the |
| | | error level (i.e., the absolute baseline of the UL TX timing error, |
| | | e.g., in nanoseconds) and/or the tolerance of the error level |
| | | between different members of a TEG. The error level and the |
| | | tolerance of the level are referred to as margin of an UL TX |
| | | timing error, hereinafter. Then, based on such information, the |
| | | LS can determine whether to combine time delay measurements |
| | | of PRSs included in multiple TEGs, e.g., because the |
| | | margins are similar, e.g., due to similar error levels and/or |
| | | similar tolerances of the level. By such combination, they can be |
| | | a tendency to achieve higher positioning accuracies. |
| | | For instance, it would be possible to use a mapping between |
| | | identities of TEGs and associated margins. Thus, based on a |
| | | corresponding mapping/codebook, the BS and/or the LS can |
| | | understand/derive the margin based on the identity of the TEG |
| | | included in the TEG report. In other examples, it would also be |
| | | possible to report the margins explicitly. |
| | | In some examples, it would be possible to use timestamps that |
| | | are indicative of a measurement time duration during which a |
| | | respective measurement of timing errors has been conducted |
| | | based on which the TEG report is being provided. |
| | | For further illustration, each TEG report can be associated with |
| | | the temporal validity. The temporal validity can correspond to |
| | | an estimation of a time duration during which the information |
| | | included in the TEG report remains up-to-date. It would be |
| | | possible to provide the temporal validity to the cellular NW. For |
| | | instance, it would be possible to incorporate respective |
| | | timestamps into the TEG report. Information on the temporal |
| | | validity could also be provided separately. Thus, the information |
| | | content of the TEG report can be augmented with respect |
| | | to this temporal dimension. |
| IV | Variable TEG | One or more parameters associated with the TEGs can be |
| | configuration | dynamically configured, e.g., by the cellular NW. This means that |
| | | certain grouping rules underlying the formation of the TEGs |
| | | can be tailored. |
| | | Accordingly, it would be possible that the UE obtains a grouping |
| | | ruleset. The grouping rules that can define one or more |
| | | parameters that are associated with the transmission TEGs. |
| | | The grouping rules that can be obtained from the cellular NW. |
| | | For example, the LS could provide the grouping ruleset to the |
| | | UE. |
| | | To give an example, it is possible to increase the positioning |
| | | accuracy by enabling configuration of the error margin of |
| | | TEGs. For instance, the LS could configure the margins of the |
| | | TEGs to be used for TEG reporting by the UE. |
| | | There are various scenarios conceivable regarding how to determine |
| | | the margins. For instance, an iterative numerical optimization |
| | | could be implemented. Machine learning could be |
| | | used to determine the margins for the TEGs. Such iterative |
| | | numerical optimization or machine-learning algorithm could be |
| | | configured to determine the error margins so that the overall |
| | | positioning accuracy is maximized, e.g., in view of certain |
| | | constraints such as signaling overhead. Thereby, situation-aware |
| | | definition of the TEGs becomes possible. TEGs can be defined |
| | | efficiently, to address a trade-off between signaling overhead |
| | | due to reporting (there is a tendency for larger signaling overhead |
| | | where measurement time durations are shorter, because |
| | | then a larger count of TEGs will be observed) on the one hand, |
| | | and positioning accuracy on the other hand (there is a tendency |
| | | for reduced positioning accuracy where the measurement |
| | | time durations are longer, because more averaging is applied |
| | | in the process of grouping). |

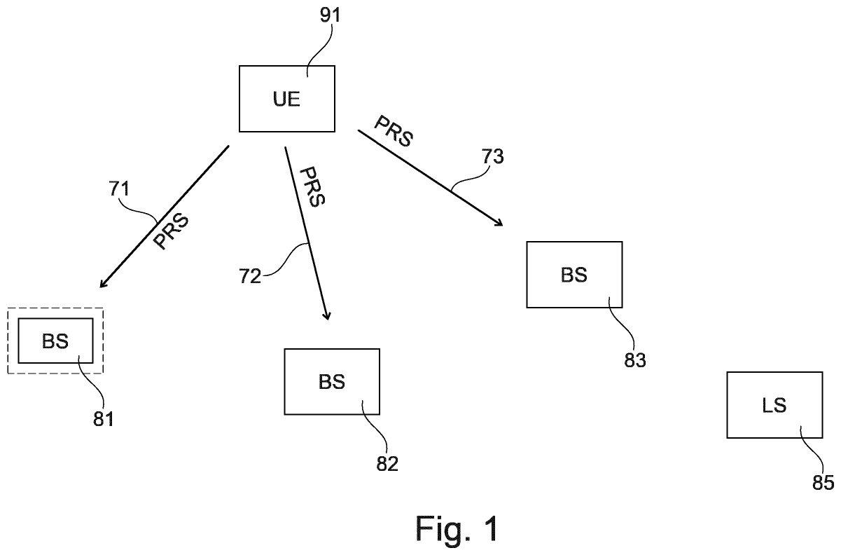

FIG. 1 schematically illustrates aspects with respect to UL time difference of arrival measurements for positioning of a UE 91. The UE 91 transmits PRSs 71-73—e.g., SRS. For instance, the UE 91 may use multiple precoders and/or multiple panels.

Different BSs 81-83 of a cellular NW 80 can receive different ones of the PRSs 71-73. As a general rule, it would also be possible that a given PRSs 71-73 is received by multiple BSs.

For instance, the BS 81 may be serving the UE 91, i.e., the UE 91 may communicate data with the BS 81.

Also illustrated is a LS 85 of the cellular NW 80, e.g., implemented by LMF in a 3GPP NR cellular NW. The BSs 81-83 and the LS 85 can communicate with each other. For instance, the BSs 81-83 can provide positioning measurement reports to the LS 85. Based on the positioning measurement reports, the LS 85 can determine the position of the UE 91, using UL-TDOA-based multiangulation.

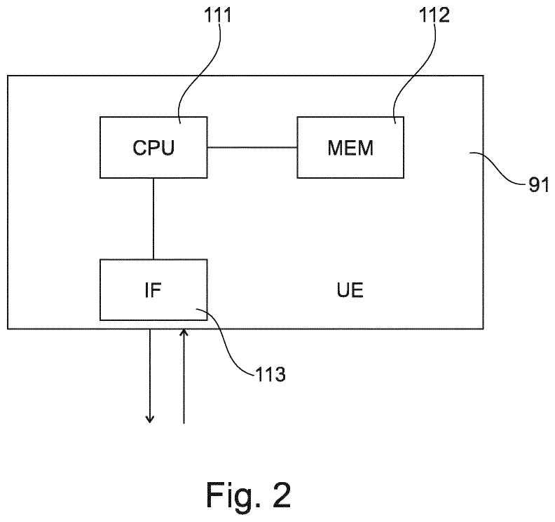

FIG. 2 schematically illustrates aspects with respect to the UE 91. The UE 91 includes a processor 111 and a memory 112. The processor can load program code from the memory 112 and execute the program code. Also, the processor 111 can communicate with nodes of the cellular NW via an interface 113. The interface 113 can, in particular, include a wireless interface. One or more TX and/or RX signal processing chains can be included in the wireless interface. Each signal processing chain can include the baseband processing, RF chain, and antenna (antenna elements, antenna panels). Different TX and/or RX signal processing chains are associated with different timing errors. Furthermore, such timing errors can change over the course of time, e.g., due to temperature variations, changing carrier frequencies, etc.

Upon executing the program code, the processor 111 can perform various techniques described herein, such as: obtaining a measurement time duration for performing measurements of UL TX timing errors when transmitting PRSs; transmitting PRSs, before, during, and after measurement time durations; determining associations between resources of a resource set for transmitting PRSs and TEGs, e.g., taking into account a grouping ruleset; providing a TEG report, e.g., taking into account a reporting ruleset.

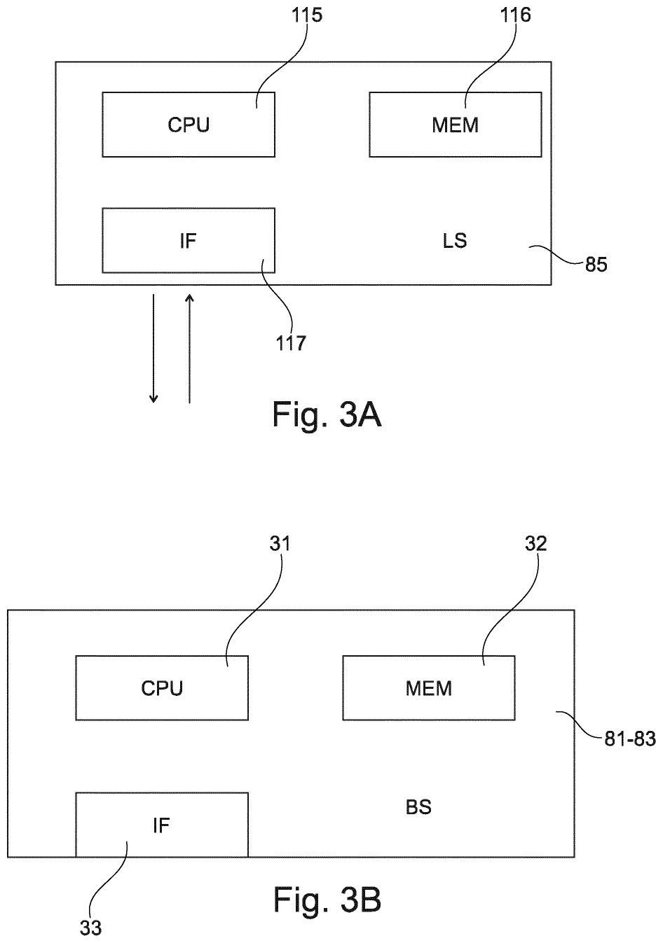

FIG. 3A schematically illustrates aspects with respect to the LS 85. The LS 85 includes a processor 115 and a memory 116. The processor 115 can load program code from the memory 116 and execute the program code. Also, the processor 115 can communicate with nodes of the cellular NW or with the UE 91 via an interface 117.

Upon executing the program code, the processor 115 can perform various techniques described herein, such as: determining and/or providing a grouping ruleset for determining TEGs; determining and/or providing a reporting ruleset for reporting TEG reports; determining and/or providing a measurement time duration for performing measurements of UL TX timing errors at the UE when transmitting PRSs; determining a TDOA between UL PRSs transmitted by the UE and received by various BSs; determining a position of the UE based on the TDOA; taking into account TEG reports provided by the UE when determining the TDOA.

FIG. 3B schematically illustrates aspects with respect to the BS 81-83. The BS 81-83 includes a processor 31 and the memory 32. The processor 31 can load program code from the memory 32 and execute the program code. Also, the processor 31 can communicate with the nodes of the cellular NW or with the UE 91 via an interface 33. For instance, UL PRS can be received via the interface 33.

Upon executing the program code, the processor 31 can perform various techniques described herein, such as: determining and/or providing a grouping ruleset for determining TEGs; determining and/or providing a reporting ruleset for reporting TEG reports; determining and/or providing a measurement time duration for performing measurements of UL TX timing errors at the UE when transmitting PRSs; determining a TDOA between UL PRSs transmitted by the UE and received by various BSs; determining a position of the UE based on the TDOA; taking into account TEG reports provided by the UE when determining the TDOA; providing a positioning measurement report to an LS; triggering a UE to transmit PRS, e.g., within a positioning measurement window, and subsequently performing positioning measurements of the arrival timing; obtaining a TEG report from the UE and subsequently, further report it to the LS.

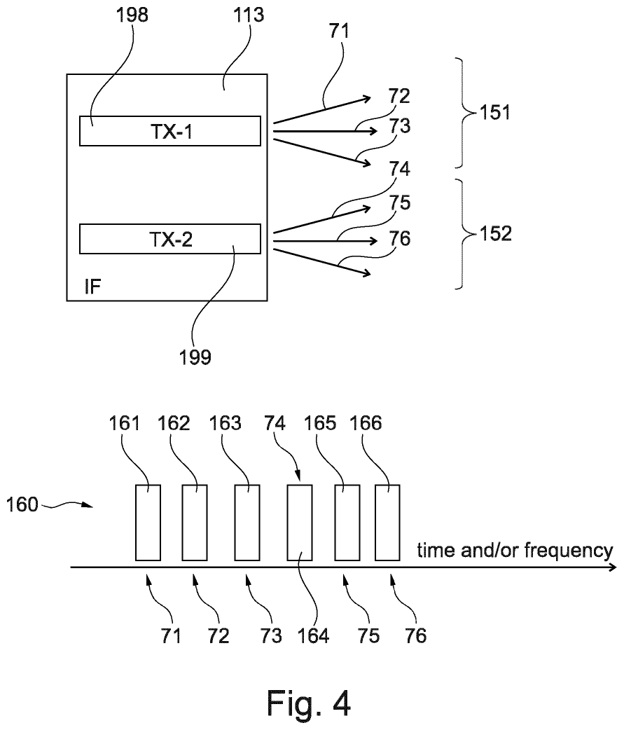

FIG. 4 (upper part) illustrates aspects in connection with the interface 113 of the UE 91. The interface 113 includes two TX signal processing chains 198, 199, e.g., each couple to different antenna panels. Each TX signal processing chain 198, 199 includes digital and analog circuitry, e.g., for precoding, amplification, modulation, interleaving, to give just a few examples.

FIG. 4 (upper part) also illustrates aspects with respect to transmission of PRSs 71-76. The PRSs 71-73 are transmitted via the TX signal processing chain 198; while the PRSs 74-76 are transmitted via the TX signal processing chain 199.

The PRSs 71-73 experience a certain UL TX timing error (within a certain margin) and accordingly belong to a TEG 151; the PRSs 74-76 experience another UL TX timing error (within a respective margin) and accordingly belong to another TEG 152.

FIG. 4 (lower part) also illustrates aspects with respect to a resource set 160. Multiple resources 161-166 are allocated to the transmission of the PRSs 71-76. The resources 161-166 are defined in time and frequency. The resources can be defined in an OFDM time-frequency resource grid defined by a carrier, subcarriers and OFDM symbols.

The PRS can be transmitted in beams. A PRS beam is associated with a given PRS resource; while the full set of PRS beams transmitted using the same common configuration on the same frequency is referred to as a PRS resource set.

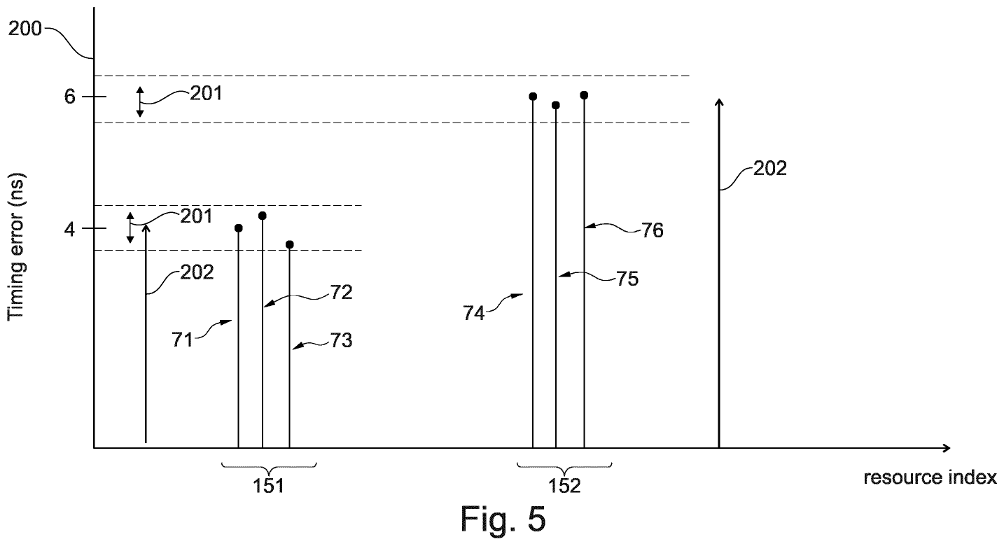

FIG. 5 illustrates aspects in connection with the error margin 201, 202 of the UL TX timing error 200 and associated with the different TEGs 151, 152. For example, the absolute error level 202 of the UL TX timing error 200 of the PRSs 71-73 is significantly lower than the absolute error level 202 of the UL TX timing error of the PRSs 74-76. On the other hand, the tolerances 201 of the TX timing errors is roughly the same for all PRSs 71-76. The tolerances 201 define a maximum variation of the absolute error level 202 of the TX timing errors within each TEG 151, 152.

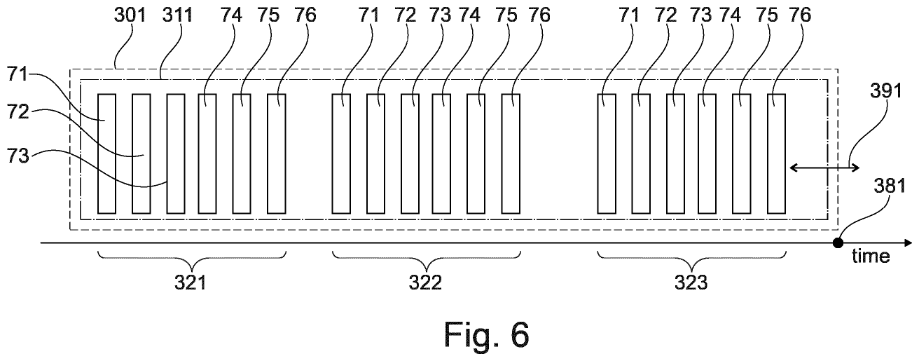

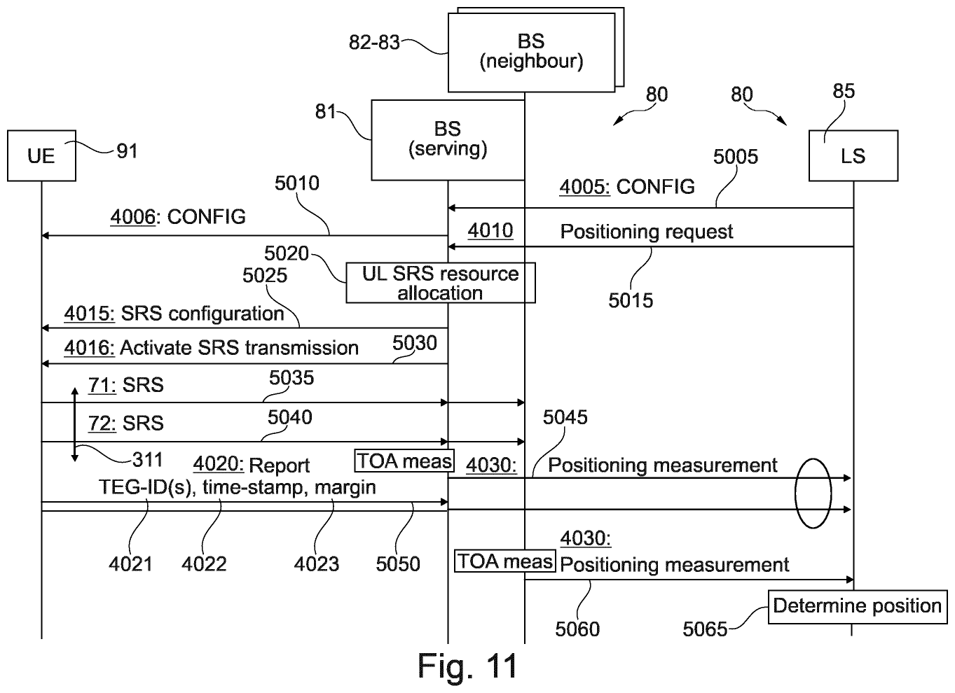

FIG. 6 illustrates aspects with respect to a positioning measurement window 301. A positioning measurement window 301 is a time window for the UE to transmit PRS so that the base station can perform positioning measurement. During the positioning measurement window 301 multiple resource sets 321-323 for transmission of the PRSs 71-76 are scheduled. For example, three repetitive resource sets (321-323) in the same frequency allocation. For instance, the positioning measurement window 301 may be configured by a positioning request obtained from the LS 85 (cf. FIG. 11: message 4015).

FIG. 6 also illustrates aspects with respect to a timing error measurement time duration 311 (dashed-dotted line in FIG. 6). In the scenario of FIG. 6, the measurement time duration 311 coincides with the positioning measurement window 301, albeit in general it is possible that the measurement time duration 311 is configured separately and independently of the positioning measurement window 301 and, accordingly, also has different temporal extents, e.g., covers only a fraction of the positioning measurement window 301.

During the measurement time duration 311, the UE 91 performs measurements of the UL timing error 200. In this example, the measurement time duration 311 covers the entire positioning measurement window 301 and in practice, it would enable the UE to perform averaging of the measured timing errors. Then, at the end of the measurement time duration 311, the UE 91 may provide a TEG report 381 that is indicative of a change of parameter values of at least one parameter associated with the transmission error timing groups 151, 152 during the measurement time duration 311 (e.g., if and only if a change occurred). As example, a time offset 391 between the last resource of resource set 323 and the providing of the TEG report 381 is illustrated. In practice, the time offset 391 can be relative to any given reference point (e.g., the first resource of the last resource set 323). The time offset 391 could be limited by a respective upper limit defined by a reporting ruleset for the TEG report 381. The TEG report 381 can be transmitted within a time gap from a reference time point, e.g., the last resource of a resource set and the maximum time gap can be NW-configured or generally configured by a reporting ruleset.

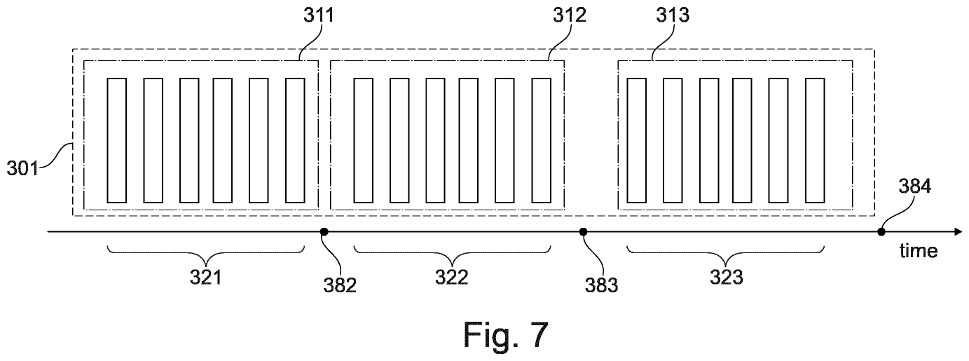

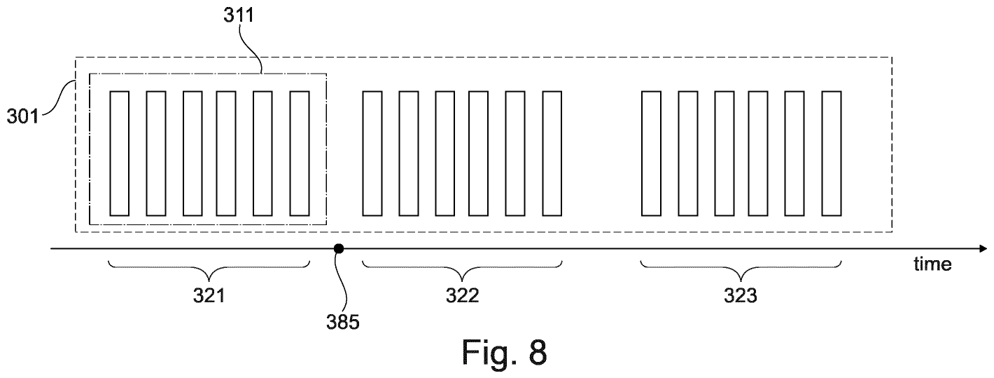

FIG. 6 illustrates one example of a relative arrangement of the measurement time duration 311 with respect to the positioning measurement window 301. Other relative arrangements are conceivable and one further option is illustrated in FIG. 7 and yet another option is illustrated in FIG. 8.

FIG. 7 illustrates aspects with respect to measurement time durations 311-313 in another scenario than FIG. 6. In FIG. 7, multiple measurement time durations 311-313 are defined, each one shorter than the positioning measurement window 301. After each measurement time duration 311-313, a respective TEG report 382-384 is provided by the UE 91. For instance, the TEG report 382 is indicative of changes of parameter values of at least one parameter associated with the TEGs 151, 152 throughout the preceding measurement time duration 311.

In the scenario of FIG. 7, it is possible to provide frequent up-to-date TEG reports 382-384.

FIG. 8 illustrates aspects with respect to the measurement duration 311 in yet another scenario, different than FIG. 6 and FIG. 7. Here, a single measurement time duration 311 is defined that includes a single resource set 321. The measurement time duration 311 only covers a fraction of the positioning measurement window 301; thus an early TEG report 385 is provided. This limit signaling overhead and minimizes the UE effort in performing timing error measurement.

As will be appreciated from FIGS. 6-8, a UE can be configured to provide TEG reports after each resource set (cf. FIG. up-to-date 7). Pros: UE provides TEG reports by providing frequent report and prompt report. Cons: It requires more resources. It is also possible to provide the TEG report after the positioning measurement FIG. window (cf. 6). Pros: Only a few resources are required (for providing TEG report), it allows averaging across different resource sets. Cons: The TEG report may only reflect the last SRS resource set, there are potentially high variation between resource set which are not captured in the final TEG report. FIG. 6-8 are examples of measurement time durations and variations are conceivable.

For instance, it would be possible to provide event-triggered TEG reports. It is also possible to provide TEG report upon a change of the timing error related to a specified TEG reaching a certain threshold or generally if there is a new TEG information that differ than the previous timing error measurement. The UE may still need to perform frequent timing error measurements. However, the UE is only required to report when there is a change in the measured timing error.

According to various examples, the information content of the TEG report 381-385 or an associated information element may vary. Some options are summarized in TAB. 3.

TABLE 3
Various options for information content of a TEG report and/or associated
information elements. For instance, in some scenarios it would be possible
that a reporting ruleset defines which information according to the
examples of TAB. 3 is to be included in a TEG report.

| | |
|---|---|
| Association | For instance, the TEG reports 381-385 may be indicative of |
| information | associations between TEGs and respective resources 161-166 |
| | allocated of a resource set to the PRSs 71-76. |
| | It would be possible to report identities of the resources |
| | associated with each TEG. |
| | Identities of the TEGs can be reported, wherein the identities |
| | have predefined meanings, e.g., in terms of the timing error margin. |
| Timing | Sometimes the LS may not be aware when the timing error measurement |
| indication | has been made. If the UL-TDOA is then based on outdated |
| | UL TX timing error measurement (i.e., a large time gap 391 between |
| | the measurement and the reporting time), the accuracy may be |
| | reduced. The LS may not be aware if the associations between TEGs |
| | and resources 161-166 are valid or not. Each TEG is accordingly |
| | associated with a respective timing indication, e.g., temporal validity. |
| | For example, timing information is associated with how long ago the |
| | measurement time duration was and a rate of change of the TEG |
| | content estimated by the UE. |
| | A time stamp - or generally the temporal validity - can also be |
| | provided to the cellular NW together with the TEG report. The time |
| | stamp could indicate the point in time at which the UL TX timing |
| | error measurement has been performed and the BS may assume a certain |
| | predetermined validity. The temporal validity could also be explicitly |
| | signaled. The time stamp could also indicate the expiry time. |
| | The time stamp could be indicative of the start of a positioning |
| | measurement window 301; and/or the start of the initial resource set |
| | of PRSs within a positioning measurement window; and/or the start of |
| | each resource set of PRSs within a positioning measurement window. |
| Error margin | The UE can indicate the error margin value (cf. FIG. 5) of the TEGs. |
| value | For example, UE reports TEG ID one with (4, 0.5). It means the average |
| | absolute timing error is 4 ns with the deviation 0.5 ns. |

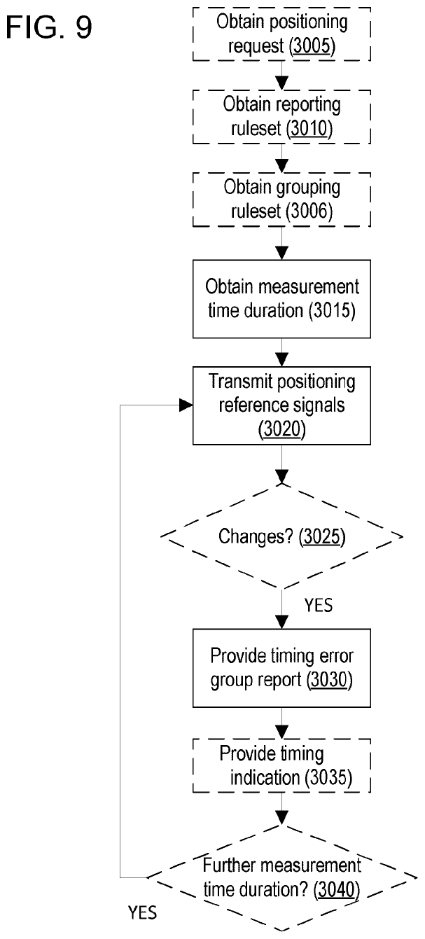

FIG. 9 is a flowchart of a method according to various examples. For instance, the method of FIG. 9 can be executed by a UE connectable or connected to a cellular NW. The cellular NW can include multiple BSs and a LS. For instance, the method of FIG. 9 could be executed by the UE 91. Specifically, it would be possible that the method of FIG. 9 is executed by the processor 111 of the UE 91 upon loading program code from the memory 112 of the UE 91.

Optional boxes are illustrated using dashed lines.

The flowchart of FIG. 9 illustrates aspects in connection with TEGs. FIG. 9 illustrates aspects in connection with configuring TEGs, reporting TEGs, and determining TEGs. Various examples according to TAB. 2 are described in connection with FIG. 9, but FIG. 9 may be modified to include only a single or some of those examples.

The techniques of FIG. 9 are generally based on the finding that for most of the RF devices, the timing error or TEG may not be constant over time depending on various factors, such as temperature change or antenna panel switching. Timing error measurement at two different time instants may not be the same due to internal clock drift, temperature change, and/or switching RF chain/antenna panels. The TEG report that would be utilized by LS should be up to date. Otherwise, LS could utilize inaccurate TEG information (e.g., past TEG information). Furthermore, the error margin to define a TEG should be properly defined so that the LS can use the reported information correctly. For instance, at a given time, the TEGs representing the observed UL TX timing errors are TEG-1 and TEG-2. At a later time, where the temperature has been raised, the UL TX timing errors have changed; accordingly, these timing errors are not appropriately captured by TEG-1 and TEG-2. Thus, a re-definition of TEG-1 and TEG-2—i.e., use of different error margins—can be helpful. Another consideration is that different vendors may have different qualities of implementation, i.e., how good the hardware is to minimize potential UL TX timing error. By defining the margin value, it would enable LS to know the collected timing errors from multiple UEs. This would be beneficial when LS utilize machine learning operation in which it utilizes rich information provided by multiple UEs.

At optional box 3005, the UE obtains a positioning request. For instance, the positioning request may be obtained from the cellular NW, e.g., a LS or BS. The positioning request may be indicative of one or more positioning measurement windows during which the UE is requested to transmit UL PRSs.

Aspects with respect to the system architecture including the UE 91 and the LS 85 have been discussed above in connection with FIG. 1. Aspects pertaining to the UL PRSs 71-76 and associated resources 161-166 of a resource set 160 have been discussed above in connection with FIG. 4. Aspects pertaining to measurement positioning measurement windows have been discussed in connection with FIGS. 6-8.

It is not required in all scenarios that a dedicated positioning request is obtained. In some instances, transmission of PRSs may be fixedly activated.

Next, at optional box 3010, it is possible to obtain a reporting ruleset. The reporting ruleset can implement variable TEG reporting according to TAB. 2: example II. Alternatively or additionally, the reporting ruleset can implement variable TEG reporting information content according to TAB. 2: example III.

The reporting ruleset can be obtained from the cellular NW. For instance, an RRC control message may include an information element that is indicative of the reporting ruleset.

The reporting ruleset can define how or when to report the TEG report. I.e., the reporting ruleset can specify how to provide the TEG report to the cellular NW. Thereby, signaling overhead can be reduced by focusing on relevant information.

The UE may obtain reporting ruleset at least once. The reporting ruleset can be obtained multiple times, i.e., repeatedly—e.g., periodically or aperiodically-obtained by the UE. i.e., the reporting ruleset may be updated from time to time. This can be helpful where, e.g., different accuracy requirements are faced for determining the position of the UE over the course of time. Then, the signaling overhead associated with more frequent reporting of the TEG report may be accordingly adjusted.

In some scenarios, rules for providing the TEG report may be fixed. Here, it is not required to implement specific obtaining of the reporting rules or from the cellular NW. I.e., box 3010 is optional.

For instance, the reporting ruleset could define at least one trigger event triggering providing of a TEG report. An example trigger event would be the change of at least one parameter value of a parameter associated with the transmission TEGs exceeding a certain predefined threshold. The predefined threshold could be indicated in the reporting ruleset. For instance, a TEG report may be provided where the associations between PRS resources and TEGs change.

Alternatively or additionally to such event driven reporting, also time-driven reporting would be conceivable. For instance, the reporting ruleset could define a timing schedule for repeatedly—e.g., periodically or aperiodically-providing the TEG report, for instance, the TEG report could be provided at a fixed repetition rate. For instance, the timing schedule could define a maximum duration of a time gap between an end of at least one measurement time duration and said providing of the TEG report or between a resource set allocated to UL PRSs and said providing of the TEG report, a corresponding time gap 391 has been discussed in connection with FIG. 6.

Alternatively or additionally to such specifying of conditions that lead to providing of a TEG report, the reporting ruleset could also specify the information content of a TEG report. Various information elements that could be selectively activated or deactivated by the reporting ruleset have been discussed in connection with TAB. 3.

The reporting ruleset could alternatively or additionally also specify that respective parameter values of one or more parameters as listed in TAB. 3 are provided on-demand, i.e., upon a respective significant change of that parameter value. I.e., incremental updates with respect to a baseline TEG report could be provided, in accordance with the reporting ruleset.

At optional box 3006, a grouping ruleset is obtained. For instance, the grouping ruleset could be obtained from the cellular NW.

The grouping ruleset can implement variable TEG configurations according to TAB. 2: example IV.

The grouping ruleset can define a parameter associated with the transmission TEGs.

Thus, the grouping ruleset can define how to group different observed UL TX timing errors into different TEGs.

For instance, it would be possible that the grouping ruleset defines the error margins (cf. FIG. 5) associated with each TEG. For instance, the absolute error levels and/or tolerances could be defined.

Then, at box 3015, at least one measurement time duration for obtaining timing error is obtained. For instance, it would be possible that multiple measurement time durations or obtained, offset in time domain.

Various examples associated with the measurement time duration have been discussed in FIG. 6, FIG. 7, and FIG. 8.

Measurement time durations could also be repeatedly—e.g., periodically or aperiodically-obtained, i.e., updated from time to time. The measurement time duration can be adjusted while the UE operates, e.g., in connected mode towards the cellular NW.

Obtaining one or more measurement time durations at box 3015 can include loading respective predefined time durations from a memory.

Obtaining at least one measurement time duration can also include calculating a start time and the stop time of the at least one measurement time duration based on a respective repetitive timing schedule. The repetitive timing schedule could be predefined, e.g., fixed according to the communication protocol. The start time and the stop time could be relatively defined with respect to positioning measurement windows.

The measurement time duration can be obtained from the cellular NW.

According to examples, obtaining of the at least one measurement time duration can also include obtaining a respective control message that is indicative of the at least one measurement time duration from the cellular NW.

At box 3020, PRSs are transmitted. Transmitting of PRSs has been discussed in connection with FIG. 4: PRSs 71-76. The PRSs are transmitted during a positioning measurement window 301, as discussed in connection with FIG. 6, FIG. 7, and FIG. 8; the positioning measurement window can be configured at box 3005. According to the measurement time duration and during the PRS transmission, the UE also perform timing error measurement.

At optional box 3025, it can be checked whether changes occurred to at least one parameter value of at least one parameter associated with the TEGs, e.g., associations between TEGs and PRS resources, error margins, etc. Thus, an incremental check for changes to the parameter value of parameter values can be made.

It is then possible at box 3030 to provide the TEG report. For instance, where an incremental check for changes has been made at box 3025, at least one parameter value of a parameter that has undergone a change can be reported. Alternatively, it would also be possible to provide a full TEG report at box 3030, i.e., a respective of whether one or more parameter values of one or more parameters have undergone changes.

The TEG report can be provided in accordance with the reporting ruleset obtained at box 3010. The TEG report can be optionally accompanied by a respective timing indication, e.g., a respective timestamp. See box 3035. For instance, an indicator indicative of the timing indication could also be incorporated in the TEG report, such that box 3035 would not be separate from box 3030.

The timing indication can be associated with or indicative of the temporal validity of the TEG report.

At box 3040, can be optionally checked, whether a further measurement time duration has been obtained at box 3015 (the measurement time durations can be obtained multiple times, i.e., repeatedly—e.g., periodically or aperiodically—obtained). In the affirmative, boxes 3020, 3025, 3030, and 3035 can be re-executed in a respective iteration. Thereby, up-to-date TEG reports can be provided at each iteration.

FIG. 9 is only an example illustration of a respective method. For instance, the sequence of boxes could vary. For instance, box 3006 may be executed prior to box 3005 or prior to box 3010, to give just one example. Furthermore, it would be possible that, e.g., the reporting rule set is obtained multiple times, i.e., repeatedly—e.g., periodically or aperiodically—obtained, e.g., by including box 3010 in the loop of multiple iterations based on the check at box 3040. This also would apply to the grouping rule set obtained at box 3006. Likewise, it would be possible that the measurement time duration 3015 is obtained multiple times, i.e., repeatedly—e.g., periodically or aperiodically—obtained.

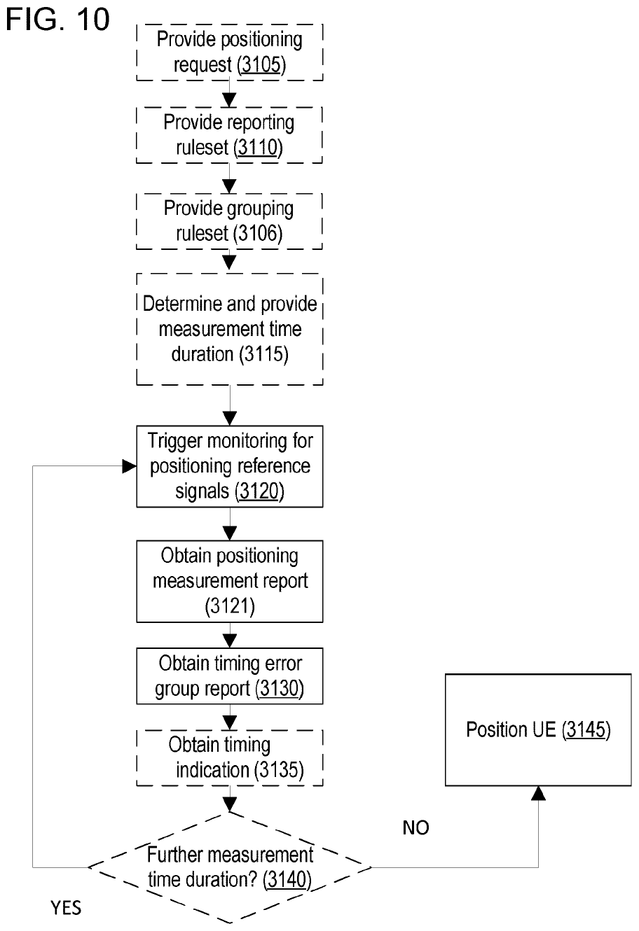

FIG. 10 is a flowchart of a method according to various examples. For instance, the method of FIG. 10 can be executed by a LS, e.g., an LMF. The LS is a node of a cellular NW including multiple BSs. A UE connected to the cellular NW can be positioned by the LS. For instance, the method of FIG. 10 could be executed by the LS 85. More specifically, the method of FIG. 10 could be executed by the processor 115 of the LS 85 upon loading and executing program code from the memory 116.

Optional boxes are illustrated using dashed lines.

The flowchart of FIG. 10 illustrates a method that is interrelated to the method of FIG. 9. Specifically, the method of FIG. 9 and the method of FIG. 10 can operate together to enable a positioning measurement of the UE.

At box 3105, it is optionally possible to provide a positioning request to the UE. Details with respect to the positioning request have been previously discussed in connection with box 3005.

At optional box 3010, it is possible to provide a reporting ruleset to a UE to be positioned. Details with such reporting ruleset have been previously discussed in connection with box 3010.

For example, the reporting ruleset could specify that the UE is to provide the TEG report after each measurement time duration; or that the UE is to provide the TEG report after multiple measurement time durations (e.g. to allow the UE to perform averaging); or that the UE is to provide the TEG report only if there is a change in its content, e.g., a change of the TEGs, exceeding the margin, etc.

At optional box 3006, it is possible to provide a grouping ruleset to the UE to be positioned. Details with respect to the grouping ruleset have been previously discussed in box 3006.

For instance, the error margins for the TEGs could thereby be configured. To determine the error margin, a machine-learning algorithm or an optimization may be employed. This can help to optimize the TEG configuration in view of a balance between signaling overhead and positioning accuracy.

At optional box 3115, it is possible to determine and provide at least one measurement time duration. The control message that is indicative of the measurement time duration can be provided to the UE. For instance, the measurement time duration could be determined based on a target positioning accuracy and/or a mobility level of the UE.

It is then possible, at box 3120, to trigger one more BS to monitor for the PRSs. This can be during the positioning measurement window or positioning measurement windows for which a respective request has been provided at box 3105.

Accordingly, at box 3121, it is possible to obtain one or positioning measurement reports from the BS or BSs. These one or more positioning measurement reports are indicative of times of arrival of PRSs at these BSs.

At box 3130, a TEG report can be obtained. This is the TEG report that is transmitted at box 3030. Optionally, at box 3135, a timing indication associated with the TEG report of box 3130 can be obtained, as discussed above in connection with box 3035.

Then, box 3140, it is possible to check whether a further measurement time duration has been determined and provided at box 3115.

In the affirmative, a further iteration of box 3120, box 3121, box 3130, at box 3135 can be executed.

Otherwise, positioning of the UE at box 3145 can commence. This can be based on time difference of arrival triangulation based on the positioning measurement report or positioning measurement reports obtained at one or more iterations of box 3121, as well as taking into account the TEG report or reports obtained at one or more iterations of box 3130.

In this regard, it would be possible to selectively combine positioning measurement reports for PRSs transmitted using resources of resource sets that are associated with different TEGs, depending on the margins of the TEGs. For instance, where based on the TEG report at box 3130 changes to the error margin have been reported, these changes can be readily taken into account at box 3145. Thus, a previous association between PRS resources and TEGs can be overridden. FIG. 11 is a signaling diagram of communication between the UE 91, the BSs 81-83 and the LS 85 of the cellular NW 80. The signaling of FIG. 11 can implement the methods according to FIG. 9 and FIG. 10. However, the signaling of FIG. 11 is only one option for implementing these methods. Other options are conceivable.

At 5005, the LS 85 provides a configuration control message 4005. For instance, the configuration control message 4005 could be indicative of a grouping ruleset (as previously discussed in connection with box 3006 and box 3106) and/or could be indicative of a reporting ruleset (as previously discussed in connection with box 3010 and box 3110). The configuration control message 4005 could be indicative of at least one measurement time duration 311. It would also be possible to use separate control messages for such information (not shown in FIG. 11).

The configuration control message 4005 is provided to the serving BS 81 which then provides the configuration control message 4006 that equates or is based on the configuration control message 4005 to the UE 91 at 5010.

A positioning protocol can be used for the configuration control messages 4005, 4006.

At 5015, the LS 85 provides a positioning request 4010 to the serving BS 81. Cf. FIG. 10: Box 3105.

The serving BS 81 then allocates resources for transmission of UL PRSs, here, specifically UL SRSs, at box 5020. Aspects with respect to such resources 161-166 that are allocated to PRSs 71-76 (or specifically SRSs) have been discussed in connection with FIG. 4.

The respective configuration control message 4015 that is indicative of one or more such resource sets including resources allocated to the transmission of UL sounding reference signals is transmitted at 5025 from the BS 81 and obtained by the UE 91.

This configuration control message 4015 can thus define a positioning measurement window, cf. FIGS. 6-8.

At 5030, the BS 81 can also activate the transmission of the sounding reference signals using a respective activation message 4016. The activation message 4016 can be used to provide, to the UE 91, a positioning time window (cf. FIGS. 6-8 where the positioning time windows 301 have been discussed).

Then, the SRSs 71, 72 are transmitted at 5035 and 5040 during the positioning time window which includes one or more respective measurement time durations 311. The BSs 81-83 monitor for the SRSs 71, 72 during the positioning time window. Cf. FIG. 9: box 3020. They can be configured accordingly by the LS 85 (not shown in FIG. 11; cf. FIG. 10: box 3120).

Next, at 5050, a TEG report 4020 (e.g., similar to one of the TEG reports 381-385 discussed in FIGS. 6-8) is provided by the UE 91 to the cellular NW 80, e.g., to the serving BS 81 or directly to the LS 85. BS 81 can provide a TEG report 4020 to the LS 85 together with 5045 positioning measurement report or separately.

The TEG report 4020 can include various information elements, cf. TAB. 3.

In the illustrated scenario, the TEG report 4020 includes associations 4021 between the various identities of the TEGs and resources used for the transmission of the sounding reference signals 71, 72 (as configured using configuration control message 4015 at 5025). The TEG report 4020 also includes a respective temporal validity, that is implicitly indicated by a respective timestamp 4022. The TEG report 4020 also is indicative of the error margins 201, 202 associated with the different TEGs, i.e., includes a respective information element 4023.

At 5045 and 5060, the BSs 81-83 provide respective positioning measurement reports 4030 (measuring TOA of the SRS 71, 72; cf. FIG. 10: box 3121) based on which the LS can then determine the position of the UE at box 5065, also taking into account the TEG report 4020. Box 5056 thus corresponds to box 3145 in FIG. 10.

Summarizing, techniques have been disclosed pertaining to reporting of information associated with TEGs.

It would be possible to report a timing of a respective transmission of positioning reference signals that has been used to determine the information associated with the TEGs. It would be possible to provide a timestamp associated with a respective measurement of the uplink transmission timing error, e.g., a respective measurement time duration. The margin of transmission error groups could be defined and reported to a location server.

For instance, such information can be reported directly after a resource set allocated to the transmission of positioning reference signals, e.g., inside or outside of a respective positioning measurement window. According to various examples, such information pertaining to timing error groups can be provided for each resource set or for a group of resource sets of allocated to the transmission of positioning reference signals.

Various aspects have been disclosed with respect to the definition of the identity of timing error groups which can represent the margin value of the timing errors associated with a TEG and/or the sequence of sounding reference signal resources that is used for the timing error measurement.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, various aspects have been disclosed in connection with uplink positioning reference signals and measuring and reporting of uplink transmission errors. Likewise, respective techniques could be applied for downlink positioning reference signals and measuring and reporting of downlink transmission errors.

1. A method, for use in a wireless communication device connected to a cellular network comprising at least one base station, of facilitating positioning of the wireless communication device, wherein the method comprises:
obtaining at least one measurement time duration for making measurements of uplink transmission timing errors associated with transmitting of positioning reference signals, each one of the at least one measurement time duration comprising at least one resource set for said transmitting of the positioning reference signals,
transmitting, for reception by the at least one base station of the cellular network, the positioning reference signals during the at least one measurement time duration and using the at least one resource set, and
based on the measurements of the uplink transmission timing errors at the wireless communication device during the at least one measurement time duration, providing, to the cellular network, a timing error group report indicative of a change of parameter values of at least one parameter associated with timing error groups during the measurement time duration, wherein each timing error group comprises one or more resources of the at least one resource set having uplink transmission timing errors within a predefined margin.

2. The method of claim 1, wherein said obtaining of the at least one measurement time duration comprises obtaining, from the cellular network, a control message indicative of the at least one measurement time duration.

3. The method of claim 1, wherein the at least one measurement time duration is obtained multiple times by the wireless communication device.

4. The method of claim 1, wherein said obtaining of the at least one measurement time duration comprises calculating a start time and a stop time of the at least one measurement time duration in accordance with a respective repetitive timing schedule.

5. The method of claim 1, wherein the timing error group report is provided to the cellular network in accordance with a reporting ruleset.

6. The method of claim 5, further comprising:
obtaining the reporting ruleset from the cellular network.

7. The method of claim 5, wherein the reporting ruleset defines at least one trigger event triggering said providing of the timing error group report.

8. The method of claim 7, wherein the at least one trigger event comprises the change of the at least one parameter value exceeding a predefined threshold.

9. The method of claim 5, wherein the reporting ruleset defines a timing schedule for repeatedly providing the timing error group report.

10. The method of claim 9, wherein the timing schedule defines a maximum duration of a time gap between an end of the at least one measurement time duration and said providing of the timing error group report.

11. The method of claim 9, wherein the timing schedule defines a maximum duration of a time gap between at least one resource of the at least one resource set and said providing of the timing error group report.

12. The method of claim 5, wherein the reporting ruleset is obtained multiple times by the wireless communication device.

13. The method of claim 1, further comprising:
obtaining a grouping ruleset defining the parameter or a further parameter associated with the timing error groups.

14. The method of claim 13, wherein the grouping ruleset is obtained from the cellular network.

15. The method of claim 13, wherein the at least one parameter or the further parameter defined by the grouping ruleset comprises the predefined margin.

16. The method of claim 1, wherein the at least one parameter associated with the timing error groups comprises associations between the one or more resources of the at least one resource set and the timing error groups.

17. The method of claim 1, wherein the at least one parameter associated with the timing error groups comprises the predefined margin of the respective uplink transmission timing errors.

18. The method of claim 1, wherein the at least one parameter comprises identities of one or more resources of the at least one resource set associated with each timing error group.

19-22. (canceled)

23. A method, for use in a network node of a cellular network, of positioning a wireless communication device connected to the cellular network based on time-difference of arrival measurements of positioning references signals transmitted by the wireless communication device for reception by at least one base station of the cellular network, wherein the method comprises:
obtaining one or more positioning measurement reports from the at least one base station, the one or more positioning measurement reports being indicative of times of arrival of the positioning reference signals at the at least one base station,
obtaining a timing error group report indicative of a change of parameter values of at least one parameter associated with timing error groups during a predetermined measurement time duration for making measurements of uplink transmission timing errors when transmitting the positioning reference signals, wherein each timing error group comprises one or more resources of the at least one resource set having uplink transmission timing errors within a predefined margin, and 28
determining a position of the wireless communication device based on the timing error group report and the one or more positioning measurement reports.

24-39. (canceled)
